(19) United States
(12) Patent Application Publication
(10) Pub. No.: US 2016/0101534 A1
(43) Pub. Date: Apr. 14, 2016

(54) Device for Cutting A Cut Resistant Material

(71) Applicant: GEFU - Kuechenboss GmbH & Co. KG, Eslohe (DE)

(72) Inventor: Rudolf Schillheim, Eshohe (DE)

(21) Appl. No.: 14/974,049

(22) Filed: Dec. 18, 2015

Related U.S. Application Data
(63) Continuation of application No. PCT/EP2014/061357, filed on Jun. 2, 2014.
Application No. PCT/EP2014/061357 is a continuation of application No. 14/919,972, filed on Oct. 22, 2015.

(51) Int. Cl. B26D 3/11; B26D 1/02; B26D 7/06

(52) U.S. Cl. CPC B26D 3/11; B26D 7/0666; B26D 1/02

(57) ABSTRACT

A device for spiral cutting a cut resistant fruit or vegetable material including at least one base element configured as an open conical funnel including a funnel edge, wherein at least one cutting device that is formed by a cutting gap and a cutting blade is arranged in an enveloping surface of the at least one base element, wherein a leftover support including a cover rim and a plunger is applicable to the funnel edge so that the leftover support is rotatable, and wherein the plunger is supported in the leftover support so that the plunger facilitates pressing leftovers of the cut resistant fruit or vegetable material into the at least one base element and cutting the leftovers to form a spiral shaped cut material.

### RELATED APPLICATIONS

This application is a continuation of application Ser. No. 14/919,972 filed on Oct. 22, 2015 which is a continuation of International Application PCT/EP2014/061357 filed on Jun. 2, 2014.

### FIELD OF THE INVENTION

The invention relates to a device for spiral cutting a cut resistant material like fruit or hard vegetables, the device including at least one base element that is configured as a conical open funnel with a funnel edge, wherein at least one cutting device that is formed by a cutting gap and a blade is arranged in an enveloping surface of the funnel.

### BACKGROUND OF THE INVENTION

A device of this type is known from European patent EP 2 218 561 B12. This device facilitates cutting fruit and firm vegetables like radishes, carrots, beets, zucchini and similar into a spiral shape. The rotatable cover that is applicable to the base element includes inner protrusions which are configured to engage the material to be cut and which facilitate a continued rotation and cutting of left overs of the material to be cut in the funnel. Since the protrusions terminate flush with the upper edge of the funnel a larger left over of the material to be cut remains which cannot be cut any further and which has to be used in a different manner.

### BRIEF SUMMARY OF THE INVENTION

Thus, it is an object of the invention to improve the known device for spiral cutting a cutting resistant material so that the material can be cut in the device with only minor leftovers remaining.

The object is achieved through a device for spiral cutting a cut resistant fruit or vegetable material including at least one base element configured as an open conical funnel including a funnel edge, wherein at least one cutting device that is formed by a cutting gap and a cutting blade is arranged in an enveloping surface of the at least one base element, wherein a leftover support including a cover rim and a plunger is applicable to the funnel edge so that the leftover support is rotatable, and wherein the plunger is supported in the leftover support so that the plunger facilitates pressing leftovers of the cut resistant fruit or vegetable material into the at least one base element and cutting the leftovers to form a spiral shaped cut material.

The device for spiral cutting a cutting resistant cutting material like fruit or vegetables includes a base element configured as a conical open funnel with a funnel rim in whose enveloping surface at least one cutting device is arranged which is formed by a cutting gap and a blade.

The device is characterized in that a left over support including a cover rim and a plunger is rotatably applicable onto the funnel opening, wherein the plunger is supported in the left over support so that leftovers of the cutting material are insertable further into the base element and cutable.

The cutting material is engaged by the impressible plunger and cut further by the cutting gap of the cutting device by rotating the left over support. This can be performed until the plunger is completely inserted into the cover rim. Thereafter only a small left over of the cutting material is included in the base element.

At least one of the base elements advantageously includes two opposite arranged cutting devices in the enveloping surface which are provided with a cutting gap with different widths. Thus, the cutting material can be cut into different thicknesses without requiring any further adjustments.

In an advantageous embodiment two base elements are joined with their pointed ends and thus form a pass through opening. Thus, the device is configured to produce endless spiral shaped cut products since only the envelope portion of the cutting material is cut by the cutting device into spiral shaped cut products during the cutting process and a core of the material to be cut moving through a center of the pass through hole takes over the function of a support pin. This support pin shaped core does not only center the material to be cut but furthermore moves the material to be cut into a defined position during the cutting process which facilitates generating endless products.

Advantageously each base element can include a cutting device in the enveloping surface, wherein the cutting device is respectively provided with a cutting gap with different width. Reversing the device facilitates using one or another cutting gap.

Each base element with its funnel edge is advantageously simultaneously configured as a base for the device. The device is then safely supportable on a base surface in each operating position.

In an advantageous embodiment the device includes two opposite lobe shaped gripping surfaces which respectively connect the funnel edges of the base elements with each other. The handling and thus the ergonomics of the device are therefore significantly improved since the device can simultaneously contact palms of a hand and fingers using the gripping surfaces.

Advantageously the plunger of the left over support includes pins at its inside which establish a form locking connection between the material to be cut and the left over support. The needles are pressed into the cutting material so that a rotation of the residual support also presses the material to be cut against the cutting device so that the material to be cut is cut.

The rotation is supported in that the plunger and the cover rim include profiles which are used as handle elements at the cover support.

The cover rim includes an annular bead on the funnel edge for rotating the left over support wherein the annular bead engages a groove in the funnel edge. Thus, the left over support is easily rotatable but also supported in its position on the funnel edge.

The plunger is supported in the cover rim by support grooves which are engaged by pinions of the cover rim. Thus, the plunger is connected with the cover rim torque proof but the plunger can slide into the funnel easily.

### BRIEF DESCRIPTION OF THE DRAWINGS

Embodiments of the invention are illustrated in more detail based on the drawing figures, wherein:

FIG. 1 illustrates a perspective view of the device:

FIG. 2 illustrates a side view of the device;

FIG. 3 illustrates a 90° rotated side view of the device according to FIG. 2;

FIG. 4 illustrates a leftover support for placement onto the device;

FIG. 5 illustrates a sectional view of the leftover support in an upper position; and

FIG. 6 illustrates a sectional view of the leftover support in a lower position.

### DETAILED DESCRIPTION OF THE INVENTION

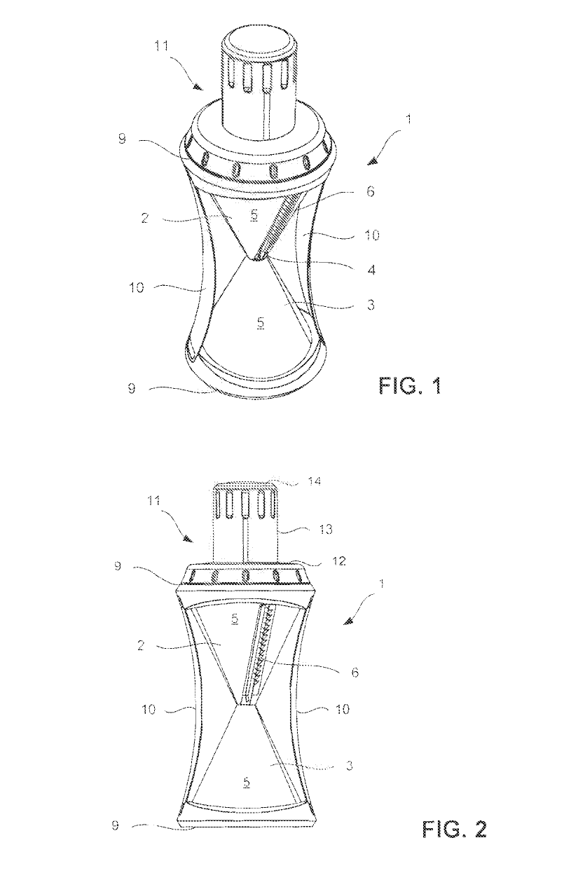

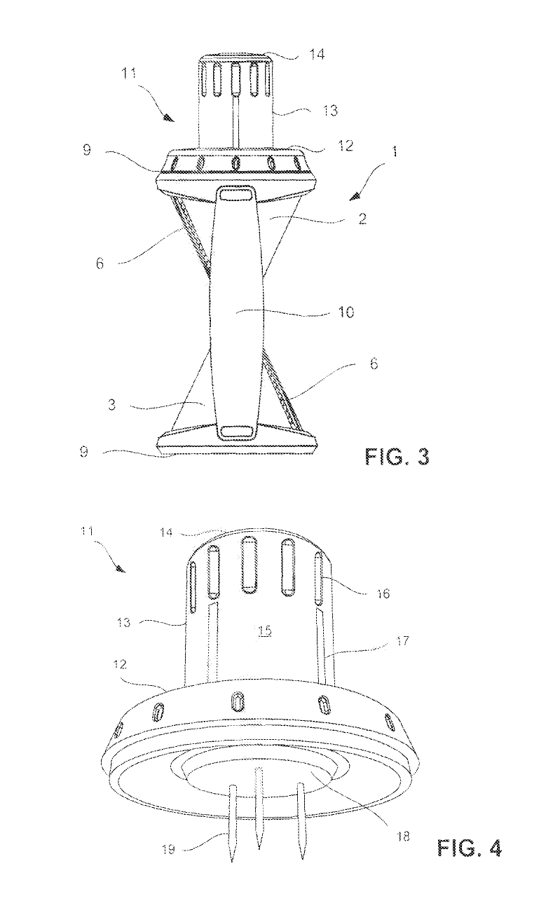

An embodiment of the device 1 for spiral cutting a cut resistant material is illustrated in FIGS. 1-3 in different views.

The device includes two funnels 2 and 3 which are joined at the pass through opening 4. Cutting gaps 6 are provided on the enveloping surfaces 5 of the two funnels 2 and 3. The enveloping surfaces are shaped so that the material is cut in different thicknesses.

The funnel edges 9 are connected with one another along the funnels 2 and 3 opposite to one another through lobe shaped slightly cambered handle surfaces 10. Thus, the device 1 on the one hand side contacts a palm of a hand and fingers of the hand with a large surface. On the other hand side this increases stability of the device 1.

The leftover support 11 is placed onto a funnel edge 9. The residual support 11 includes a cover rim 12 and a plunger 13 which is closed by a cap 14 on top.

The left over support 11 is illustrated in more detail in FIG. 4. The leftover support 11 includes profiles 16 at its circumferential surface 15 and at an edge of the cover rim 12, wherein the profiles 16 facilitate rotating the left over support 11. The plunger 13 is supported in the cover rim 12 by support grooves 17 so that the plunger 13 can be pressed down easily but so that it is not rotate able relative to the cover rim 12. Pins 19 are arranged at the inner surface 18 of the plunger 13 wherein the pins are pressed into the material to be cut.

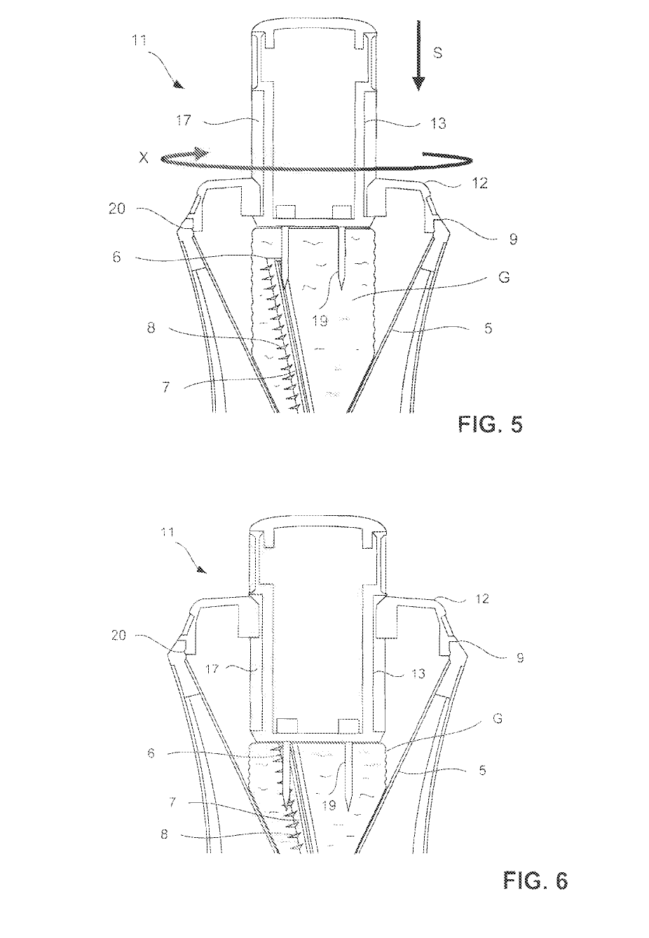

The function of the left over support 11 is illustrated in more detail in FIGS. 5 and 6. The plunger 13 is supported in the cover rim 12 with support grooves 17 of the plunger so that the plunger can impart a thrust force S from above onto the material G to be cut. Simultaneously the material G to be cut is pressed against the cutting gaps 6 by rotating the plunger 13 together with the cover rim 12 in the rotation direction X.

The cutting blade 7 and the cutting mandrels 8 are arranged at the cutting gap 6 and cut the material G further. In order to safely facilitate a rotation of leftovers of the material G to be cut the pins 19 are pressed into the material G to be cut.

Rotating the left over support 11 on the funnel edge 9 is facilitated by the bead 20 at the cover rim 12. The bead 20 engages a groove in the funnel edge 9. This represents a snap locking connection which provides support for the left over support 11 on the funnel edge 9 but does not impair a rotation in a rotation direction X.

### REFERENCE NUMERALS AND DESIGNATIONS

1 spiral cutting device
2 first funnel
3 second funnel
4 pass through opening
5 enveloping surface
6 cutting gap
7 cutting blade
8 cutting mandrel
9 funnel edge of funnel opening
10 gripping surface
11 left over support
12 cover rim
13 plunger
14 cap
15 circumferential surface
16 profile
17 support groove
18 inner surface
19 pin
20 bead
G material to be cut
S thrust force
X rotation direction

What is claimed is:

1. A device for spiral cutting a cut resistant fruit or vegetable material, comprising:
at least one base element configured as an open conical funnel including a funnel edge,
wherein at least one cutting device that is formed by a cutting gap and a cutting blade is arranged in an enveloping surface of the at least one base element,
wherein a leftover support including a cover rim and a plunger is applicable to the funnel edge so that the leftover support is rotatable, and
wherein the plunger is supported in the leftover support so that the plunger facilitates pressing leftovers of the cut resistant fruit or vegetable material into the at least one base element and cutting the leftovers to form a spiral shaped cut material.

2. The device according to claim 1, wherein the cutting device includes cutting mandrels which cut the spiral shaped cut material into cutting widths.

3. The device according to claim 1,
wherein the at least one base element includes two cutting devices arranged opposite to each other in the enveloping surface, and
wherein the cutting devices are respectively provided with a cutting gap with a different cutting width.

4. The device according to claim 1, wherein two base elements are joined with pointed ends of the two base elements and thus form a pass through opening.

5. The device according to claim 4,
wherein each of the two base elements includes a cutting device in the enveloping surface, and
wherein the cutting device is respectively provided with a cutting gap with different width.

6. The device according to claim 4, wherein funnel edges of the two base elements are simultaneously configured as pedestals for the device.

7. The device according to claim 4, wherein the device includes two opposite lobe shaped gripping surfaces respectively connecting funnel openings of the two base elements with one another.

8. The device according to claim 1, wherein the plunger of the leftover support includes pins which provide a form locking engagement between the leftovers to be cut and the leftover support.

9. The device according to claim 1, wherein the plunger and the cover rim include profiles which from handle elements of the leftover support.

10. The device according to claim 1, wherein the cover rim includes an annular bead which engages a groove in the funnel edge.

11. The device according to claim 1, wherein the plunger includes support grooves which are engaged by pinions of the cover rim.
